(19) United States
(12) Patent Application Publication
(10) Pub. No.: US 2010/0223364 A1
(43) Pub. Date: Sep. 2, 2010

(54) SYSTEM AND METHOD FOR NETWORK TRAFFIC MANAGEMENT AND LOAD BALANCING

(75) Inventor: COACH WEI, CAMBRIDGE, MA (US)

Correspondence Address: AKC PATENTS, 215 GROVE ST., NEWTON, MA, 02466, US

(73) Assignee: YOTTAA INC, CAMBRIDGE, MA (US)

(21) Appl. No.: 12/713,042

(22) Filed: Feb. 25, 2010

Related U.S. Application Data
(60) Provisional application No. 61/156,050, filed on Feb. 27, 2009.
(60) Provisional application No. 61/165,250, filed on Mar. 31, 2009.

(51) Int. Cl. G06F 15/16; G06F 15/177; G06F 15/173; G06F 9/455

(52) U.S. Cl. 709/220; 709/235; 709/238; 718/1

(57) ABSTRACT

A method for providing load balancing and failover among a set of computing nodes running a network accessible computer service includes providing a computer service that is hosted at one or more servers comprised in a set of computing nodes and is accessible to clients via a first network. Providing a second network including a plurality of traffic processing nodes and load balancing means. The load balancing means is configured to provide load balancing among the set of computing nodes running the computer service. Providing means for redirecting network traffic comprising client requests to access the computer service from the first network to the second network. Providing means for selecting a traffic processing node of the second network for receiving the redirected network traffic comprising the client requests to access the computer service and redirecting the network traffic to the traffic processing node via the means for redirecting network traffic. For every client request for access to the computer service, determining an optimal computing node among the set of computing nodes running the computer service by the traffic processing node via the load balancing means, and then routing the client request to the optimal computing node by the traffic processing node via the second network.

### CROSS REFERENCE TO RELATED CO-PENDING APPLICATIONS

This application claims the benefit of U.S. provisional application Ser. No. 61/156,050 filed on Feb. 27, 2009 and entitled METHOD AND SYSTEM FOR SCALABLE, FAULT-TOLERANT TRAFFIC MANAGEMENT AND LOAD BALANCING, which is commonly assigned and the contents of which are expressly incorporated herein by reference.

This application claims the benefit of U.S. provisional application Ser. No. 61/165,250 filed on Mar. 31, 2009 and entitled CLOUD ROUTING NETWORK FOR BETTER INTERNET PERFORMANCE, RELIABILITY AND SECURITY, which is commonly assigned and the contents of which are expressly incorporated herein by reference.

### FIELD OF THE INVENTION

The present invention relates to network traffic management and load balancing in a distributed computing environment.

### BACKGROUND OF THE INVENTION

The World Wide Web was initially created for serving static documents such as Hyper-Text Markup Language (HTML) pages, text files, images, audio and video, among others. Its capability of reaching millions of users globally has revolutionized the world. Developers quickly realized the value of using the web to serve dynamic content. By adding application logic as well as database connectivity to a web site, the site can support personalized interaction with each individual user, regardless of how many users there are. We call this kind of web site “dynamic web site” or “web application” while a site with only static documents is called “static web site”. It is very rare to see a web site that is entirely static today. Most web sites today are dynamic and contain static content as well as dynamic code. For instance, Amazon.com, eBay.com and MySpace.com are well known examples of dynamic web sites (web applications).

Referring to FIG. 1, a static web site 145 includes web server 150 and static documents 160. When web browser 110 sends request 120 over the Internet 140, web server 150 serves the corresponding document as response 130 to the client.

In contrast, FIG. 2 shows the architecture of a web application (“dynamic web site”). The dynamic web site infrastructure 245 includes not only web server 250 (and the associated static documents 255), but also middleware such as Application Server 260 and Database Server 275. Application Server 260 is where application logic 265 runs and Database server 275 manages access to data 280.

In order for a web application to be successful, its host infrastructure must meet performance, scalability and availability requirements. “Performance” refers to the application's responsiveness to user interactions. “Scalability” refers to an application's capability to perform under increased load demand. “Availability” refers to an application's capability to deliver continuous, uninterrupted service. With the exponential growth of the number of Internet users, access demand can easily overwhelm the capacity of a single server computer.

An effective way to address performance, scalability and availability concerns is to host a web application on multiple servers (server clustering), or sometimes replicate the entire application, including documents, data, code and all other software, to two different data centers (site mirroring), and load balance client requests among these servers (or sites). Load balancing spreads the load among multiple servers. If one server fails, the load balancing mechanism will direct traffic away from the failed server so that the site is still operational.

For both server clustering and site mirroring, a variety of load balancing mechanisms have been developed. They all work fine in their specific context. However, both server clustering and site mirroring have significant limitations. Both approaches provision a “fixed” amount of infrastructure capacity, while the load on a web application is not fixed.

In reality, there is no “right” amount of infrastructure capacity to provision for a web application because the load on the application can swing from zero to millions of hits within a short period of time when there is a traffic spike. When under-provisioned, the application may perform poorly or even become unavailable. When over-provisioned, the over-provisioned capacity is wasted. To be conservative, a lot of web operators end up purchasing significantly more capacity than needed. It is common to see server utilization below 20% in a lot of data centers today, resulting in substantial capacity waste.

Over the recent years, cloud computing has emerged as an efficient and more flexible way to do computing. According to Wikipedia, cloud computing “refers to the use of Internet-based (i.e. Cloud) computer technology for a variety of services. It is a style of computing in which dynamically scalable and often virtualized resources are provided as a service over the Internet. Users need not have knowledge of, expertise in, or control over the technology infrastructure ‘in the cloud’ that supports them”. The word “cloud” is a metaphor, based on how it is depicted in computer network diagrams, and is an abstraction for the complex infrastructure it conceals. In this document, we use the term “Cloud Computing” to refer to the utilization of a network-based computing infrastructure that includes many inter-connected computing nodes to provide a certain type of service, of which each node may employ technologies like virtualization and web services. The internal works of the cloud itself are concealed from the user.

One of the enablers for cloud computing is virtualization. Wikipedia explains that “virtualization is a broad term that refers to the abstraction of computer resource”. It includes “platform virtualization” and “resource virtualization”. “Platform virtualization” separates an operating system from the underlying platform resources and “resource virtualization” virtualizes specific system resources, such as storage volumes, name spaces, and network resource, among others. VMWare is a company that provides virtualization software to “virtualize” computer operating systems from the underlying hardware resources. With virtualization, one can use software to start, stop and manage “virtual machine” (VM) nodes in a computing environment. Each “virtual machine” behaves just like a regular computer from an external point of view. One can install software onto it, delete files from it and run programs on it, though the “virtual machine” itself is just a software program running on a “real” computer.

Other enablers for cloud computing are the availability of commodity hardware and the low cost and high computing power of commodity hardware. For a few hundred dollars, one can acquire a computer today that is more powerful than a machine that would have cost ten times more twenty years ago. Though an individual commodity machine itself may not be reliable, putting many of them together can produce an extremely reliable and powerful system. Amazon.com's Elastic Computing Cloud (EC2) is an example of a cloud computing environment that employs thousands of commodity machines with virtualization software to form an extremely powerful computing infrastructure.

By utilizing commodity hardware and virtualization, cloud computing can increase data center efficiency, enhance operational flexibility and reduce costs. However, running web applications in a cloud computing environment like Amazon EC2 creates new requirements for traffic management and load balancing because of the frequent node stopping and starting. In the cases of server clustering and site mirroring, stopping a server or server failure are exceptions. The corresponding load balancing mechanisms are also designed to handle such occurrences as exceptions. In a cloud computing environment, server reboot and server shutdown are assumed to be common occurrences rather than exceptions. The assumption that individual nodes are not reliable is at the center of design for a cloud system due to its utilization of commodity hardware. There are also business reasons to start or stop nodes in order to increase resource utilization and reduce costs. Naturally, the traffic management and load balancing system required for a cloud computing environment must be responsive to these node status changes.

There have been various load balancing techniques developed for clustering and site mirroring. Server clustering is a well known approach in the prior art for improving an application's performance and scalability. The idea is to replace a single server node with multiple servers in the application architecture. Performance and scalability are both improved because application load is shared by the multiple servers. If one of the servers fails, other servers take over, thereby preventing availability loss. An example is shown in FIG. 3 where multiple web servers form a Web Server Farm 350, multiple application servers form an Application Server Farm 360, and multiple database servers form a Database Server Farm 380. Load balancer 340 is added to the architecture to distribute load to different servers. Load balancer 340 also detects node failure and re-routes requests to the remaining servers if a server fails.

There are hardware load balancers available from companies like Cisco, Foundry Networks, F5 Networks, Citrix Systems, among others. Popular software load balancers include Apache HTTP Server's modproxy and HAProxy. Examples of implementing load balancing for a server cluster are described in U.S. Pat. Nos. 7,480,705 and 7,346,695 among others. However, such load balancing techniques are designed to load balance among nodes in the same data center, do not respond well to frequent node status changes, and require purchasing, installing and maintaining special software or hardware.

A more advanced approach than server clustering to enhance application availability is called “site mirroring” and is described in U.S. Pat. Nos. 7,325,109, 7,203,796, and 7,111,061, among others. It replicates an entire application, including documents, code, data, web server software, application server software, database server software, and so on, to another geographic location, creating two geographically separated sites mirroring each other. Compared to server clustering, site mirroring has the advantage that it provides server availability even if one site completely fails. However, it is more complex than server clustering because it requires data synchronization between the two sites.

A hardware device called “Global Load Balancing Device” is typically used for load balancing among the multiple sites. However, this device is fairly expensive to acquire and the system is very expensive to set up. Furthermore, the up front costs are too high for most applications, special skill sets are required for managing the set up and it is time consuming to make changes. The ongoing maintenance is expensive too. Lastly, the set of global load balancing devices forms a single point of failure.

A third approach for load balancing has been developed in association with Content Delivery Networks (CDN). Companies like Akamai and Limelight Networks operate a global content delivery infrastructure comprising tens of thousands of servers strategically placed across the globe. These servers cache web site content (static documents) produced by their customers (content providers). When a user requests such web site content, a routing mechanism finds an appropriate caching server to serve the request. By using content delivery service, users receive better content performance because content is delivered from an edge server that is closer to the user.

Within the context of content delivery, a variety of techniques have been developed for load balancing and traffic management. For example, U.S. Pat. Nos. 6,108,703, 7,111,061 and 7,251,688 explain methods for generating a network map and feed the network map to a Domain Name System (DNS) and then selecting an appropriate content server to serve user requests. U.S. Pat. Nos. 6,754,699, 7,032,010 and 7,346,676 disclose methods that associate an authorative DNS server with a list of client DNS server and then return an appropriate content server based on metrics such as latency. Though these techniques have been successful, they are designed to manage traffic for caching servers of content delivery networks. Furthermore, such techniques are not able to respond to load balancing and failover status changes in real time because DNS results are typically cached for at least a “Time-To-Live” (TTL) period and thus changes are not be visible until the TTL expires.

The emerging cloud computing environments add new challenges to load balancing and failover. In a cloud computing environment, some of the above mentioned server nodes may be “Virtual Machines” (VM). These “virtual machines” behave just like a regular physical server. In fact, the client does not even know the server application is running on “virtual machines” instead of physical servers. These “virtual machines” can be clustered, or mirrored at different data centers, just like the traditional approaches to enhance application scalability. However, unlike traditional clustering or site mirroring, these virtual machines can be started, stopped and managed using pure computer software, so it is much easier to manage them and much more flexible to make changes. However, the frequent starting and stopping of server nodes in a cloud environment adds a new requirement from a traffic management perspective.

Accordingly, it is desirable to provide a loading balancing and traffic management system that efficiently directs traffic to a plurality of server nodes, responds to server node starting and stopping in real time, while enhancing an application's performance, scalability and availability. It is also desirable to have a load balancing system that is easy to implement, easy to maintain, and works well in cloud computing environments.

### SUMMARY OF THE INVENTION

In general, in one aspect, the invention features a method for providing load balancing and failover among a set of computing nodes running a network accessible computer service. The method includes providing a computer service that is hosted at one or more servers comprised in a set of computing nodes and is accessible to clients via a first network. Providing a second network including a plurality of traffic processing nodes and load balancing means. The load balancing means is configured to provide load balancing among the set of computing nodes running the computer service. Providing means for redirecting network traffic comprising client requests to access the computer service from the first network to the second network. Providing means for selecting a traffic processing node of the second network for receiving the redirected network traffic comprising the client requests to access the computer service and redirecting the network traffic to the traffic processing node via the means for redirecting network traffic. For every client request for access to the computer service, determining an optimal computing node among the set of computing nodes running the computer service by the traffic processing node via the load balancing means, and then routing the client request to the optimal computing node by the traffic processing node via the second network.

Implementations of this aspect of the invention may include one or more of the following. The load balancing means is a load balancing and failover algorithm. The second network is an overlay network superimposed over the first network. The traffic processing node inspects the redirected network traffic and routes all client requests originating from the same client session to the same optimal computing node. The method may further include directing responses from the computer service to the client requests originating from the same client session to the traffic processing node of the second network and then directing the responses by the traffic processing node to the same client. The network accessible computer service is accessed via a domain name within the first network and the means for redirecting network traffic resolves the domain name of the network accessible computer service to an IP address of the traffic processing node of the second network. The network accessible computer service is accessed via a domain name within the first network and the means for redirecting network traffic adds a CNAME to a Domain Name Server (DNS) record of the domain name of the network accessible computer service and resolves the CNAME to an IP address of the traffic processing node of the second network. The network accessible computer service is accessed via a domain name within the first network and the second network further comprises a domain name server (DNS) node and the DNS node receives a DNS query for the domain name of the computer service and resolves the domain name of the network accessible computer service to an IP address of the traffic processing node of the second network. The traffic processing node is selected based on geographic proximity of the traffic processing node to the request originating client. The traffic processing node is selected based on metrics related to load conditions of the traffic processing nodes of the second network. The traffic processing node is selected based on metrics related to performance statistics of the traffic processing nodes of the second network. The traffic processing node is selected based on a sticky-session table mapping clients to the traffic processing nodes. The optimal computing node is determined based on the load balancing algorithm. The load balancing algorithm utilizes optimal computing node performance, lowest computing cost, round robin or weighted traffic distribution as computing criteria. The method may further include providing monitoring means for monitoring the status of the traffic processing nodes and the computing nodes. Upon detection of a failed traffic processing node or a failed computing node, redirecting in real-time network traffic to a non-failed traffic processing node or routing client requests to a non-failed computing node, respectively. The optimal computing node is determined in real-time based on feedback from the monitoring means. The second network comprises virtual machines nodes. The second network scales its processing capacity and network capacity by dynamically adjusting the number of traffic processing nodes. The computer service is a web application, web service or email service.

In general, in another aspect, the invention features a system for providing load balancing among a set of computing nodes running a network accessible computer service. The system includes a first network providing network connections between a set of computing nodes and a plurality of clients, a computer service that is hosted at one or more servers comprised in the set of computing nodes and is accessible to clients via the first network and a second network comprising a plurality of traffic processing nodes and load balancing means. The load balancing means is configured to provide load balancing among the set of computing nodes running the computer service. The system also includes means for redirecting network traffic comprising client requests to access the computer service from the first network to the second network, means for selecting a traffic processing node of the second network for receiving the redirected network traffic, means for determining for every client request for access to the computer service an optimal computing node among the set of computing nodes running the computer service by the traffic processing node via the load balancing means, and means for routing the client request to the optimal computing node by the traffic processing node via the second network. The system also includes real-time monitoring means that provide real-time status data for selecting optimal traffic processing nodes and optimal computing nodes during traffic routing, thereby minimizing service disruption caused by the failure of individual nodes.

Among the advantages of the invention may be one or more of the following. The present invention deploys software onto commodity hardware (instead of special hardware devices) and provides a service that performs global traffic management. Because it is provided as a web delivered service, it is much easier to adopt and much easier to maintain. There is no special hardware or software to purchase, and there is nothing to install and maintain. Comparing to load balancing approaches in the prior art, the system of the present invention is much more cost effective and flexible in general. Unlike load balancing techniques for content delivery networks, the present invention is designed to provide traffic management for dynamic web applications whose content can not be cached. The server nodes could be within one data center, multiple data centers, or distributed over distant geographic locations. Furthermore, some of these server nodes may be “Virtual Machines” running in a cloud computing environment.

The present invention is a scalable, fault-tolerant traffic management system that performs load balancing and failover. Failure of individual nodes within the traffic management system does not cause the failure of the system. The present invention is designed to run on commodity hardware and is provided as a service delivered over the Internet. The system is horizontally scalable. Computing power can be increased by just adding more traffic processing nodes to the system. The system is particularly suitable for traffic management and load balancing for a computing environment where node stopping and starting is a common occurrence, such as a cloud computing environment.

Furthermore, the present invention also takes session stickiness into consideration so that requests from the same client session can be routed to the same computing node persistently when session stickiness is required. Session stickiness, also known as “IP address persistence” or “server affinity” in the art, means that different requests from the same client session will always to be routed to the same server in a multi-server environment. “Session stickiness” is required for a variety of web applications to function correctly.

Examples of applications of the present invention include the following among others. Directing requests among multiple replicated web application instances running on different servers within the same data center, as shown in FIG. 5. Load balancing between replicated web application instances running at multiple sites (data centers), as shown in FIG. 6. Directing traffic to nodes in a cloud computing environment, as shown in FIG. 7. In FIG. 7, these nodes are shown as “virtual machine” (VM) nodes. Managing traffic to a 3-tiered web application running in a cloud computing environment. Each tier (web server, application server, database server) contains multiple VM instances, as shown in FIG. 8. Managing traffic to mail servers in a multi-server environment. As an example, FIG. 9 shows that these mail servers also run as VM nodes in a computing cloud.

The present invention may also be used to provide an on-demand service delivered over the Internet to web site operators to help them improve their web application performance, scalability and availability, as shown in FIG. 20. Service provider H00 manages and operates a global infrastructure H40 providing web performance related services, including monitoring, load balancing, traffic management, scaling and failover, among others. The global infrastructure has a management and configuration user interface (UI) H30, as shown in FIG. 20, for customers to purchase, configure and manage services from the service provider. Customers include web operator H10, who owns and manages web application H50. Web application H50 may be deployed in one data center, or in a few data centers, in one location or in multiple locations, or run as virtual machines in a distributed cloud computing environment. H40 provides services including monitoring, traffic management, load balancing and failover to web application H50 which results in delivering better performance, better scalability and better availability to web users H20. In return for using the service, web operator H10 pays a fee to service provider H00.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

FIG. 1 is block diagram of a static web site;

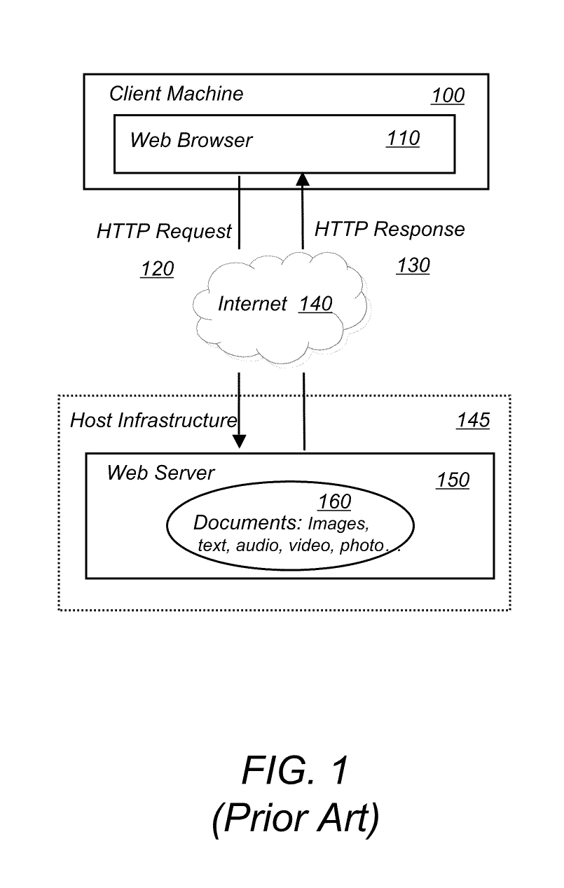

FIG. 2 is block diagram of a typical web application (“dynamic web site”);

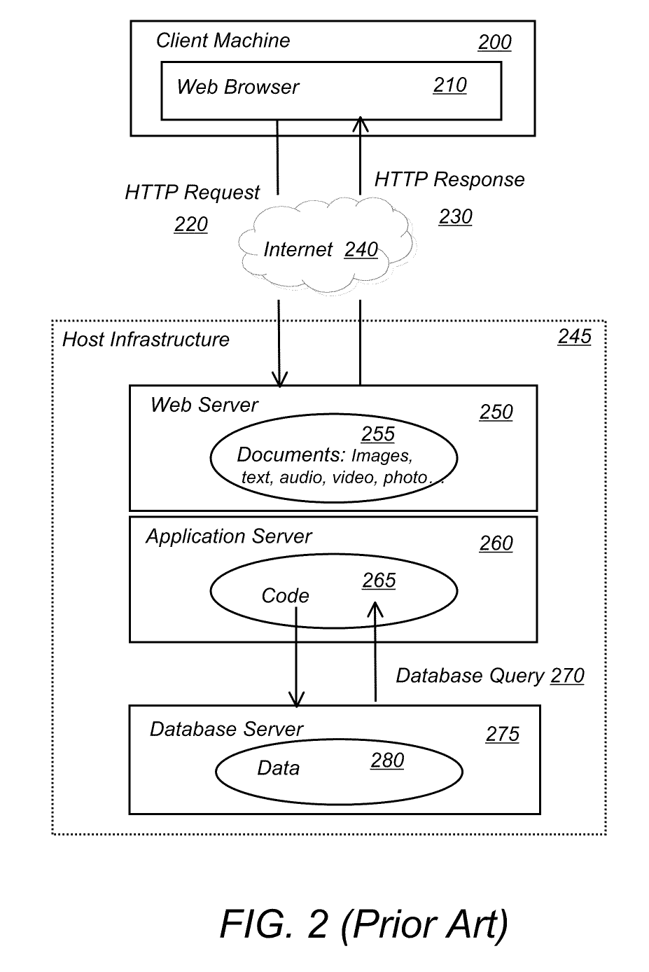

FIG. 3 is a block diagram showing load balancing in a cluster environment via a load balancer device (prior art);

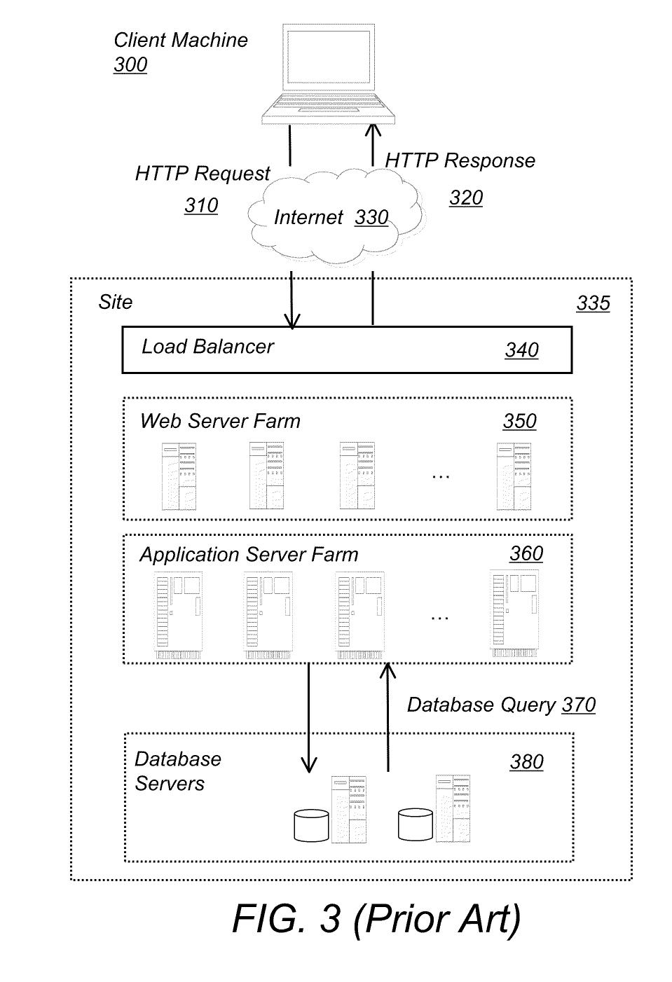

FIG. 4 is a schematic diagram showing load balancing between two mirrored sites via a Global Load Balancing Device to (prior art);

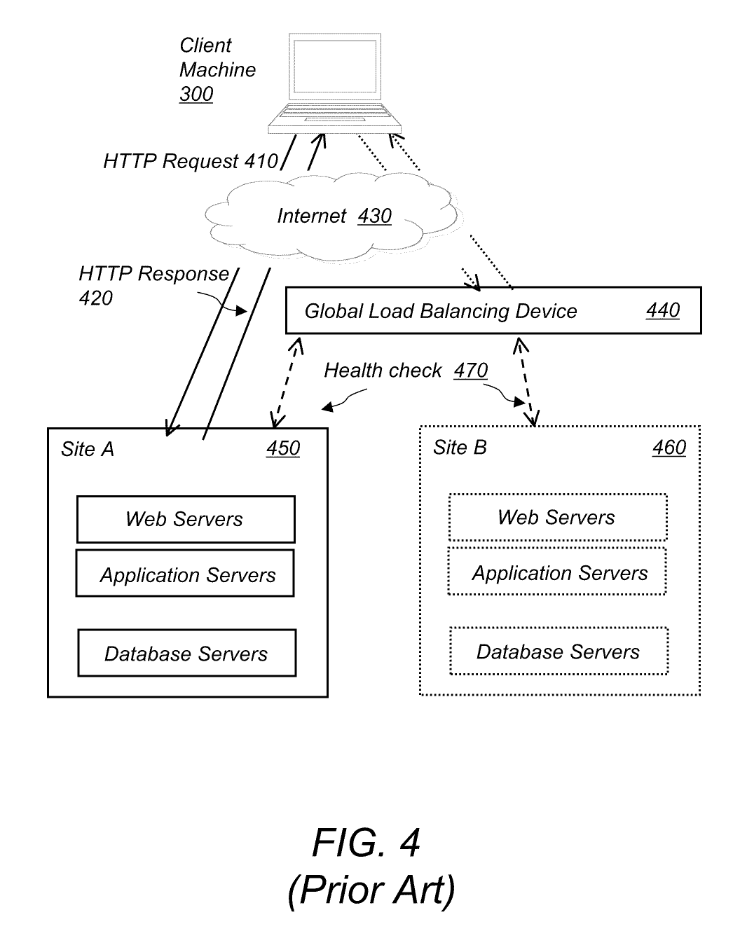

FIG. 5A is a schematic diagram of a first embodiment of the present invention;

FIG. 5B is a block diagram of the cloud routing system of FIG. 5A;

FIG. 5C is a block diagram of the traffic processing pipeline in the system of FIG. 5A;

FIG. 5 is a schematic diagram of an example of the present invention used for load balancing of traffic to multiple replicated web application instances running on different servers housed in the same data center;

FIG. 6 is a schematic diagram of an example of the present invention used for load balancing of traffic to multiple replicated web application instances running on different servers housed in different data centers;

FIG. 7 is a schematic diagram of an example of the present invention used for load balancing of traffic to multiple replicated web application instances running on “virtual machine” (VM) nodes in a cloud computing environment;

FIG. 8 is schematic diagram of an example of using the present invention to manage traffic to a 3-tiered web application running in a cloud computing environment;

FIG. 9 is schematic diagram of an example of using the present invention to manage traffic to mail servers running in a cloud environment;

FIG. 10 is schematic diagram of an embodiment of the present invention referred to as “Yottaa”;

FIG. 11 is a flow diagram showing how Yottaa of FIG. 10 processes client requests;

FIG. 12 is a block diagram showing the architecture of a Yottaa Traffic Management node of FIG. 10;

FIG. 13 shows how an HTTP request is served from a 3-tiered web application using the present invention;

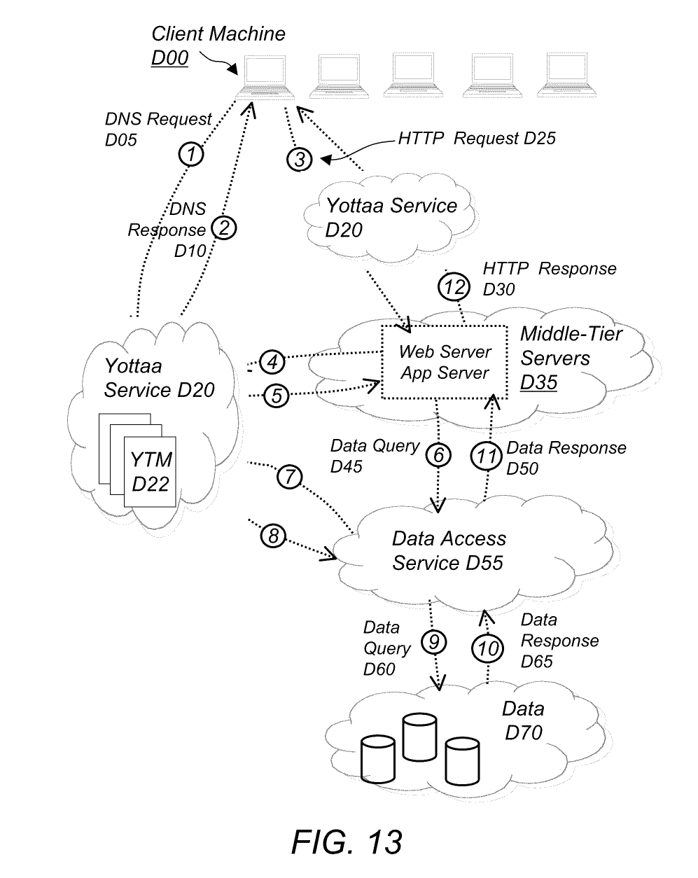

FIG. 14 shows the various function blocks of an Application Delivery Network that uses the traffic management system of the present invention;

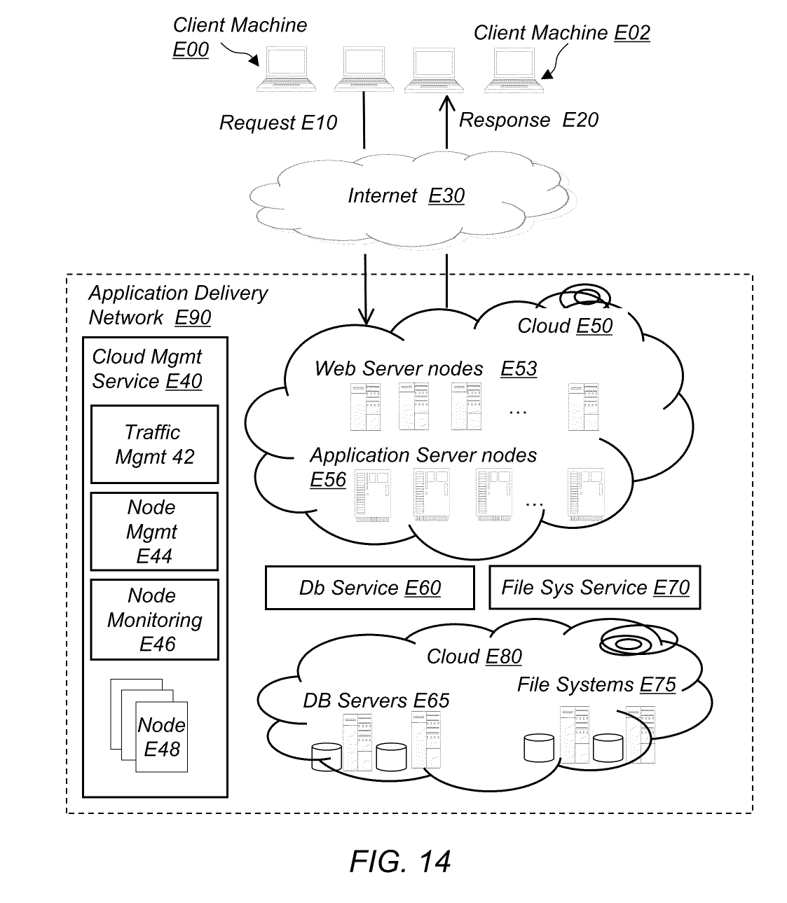

FIG. 15 shows the life cycle of a Yottaa Traffic Management node;

FIG. 16 shows the architecture of a Yottaa Manager node;

FIG. 17 shows the life cycle of a Yottaa Manager node;

FIG. 18 shows the architecture of a Yottaa Monitor node;

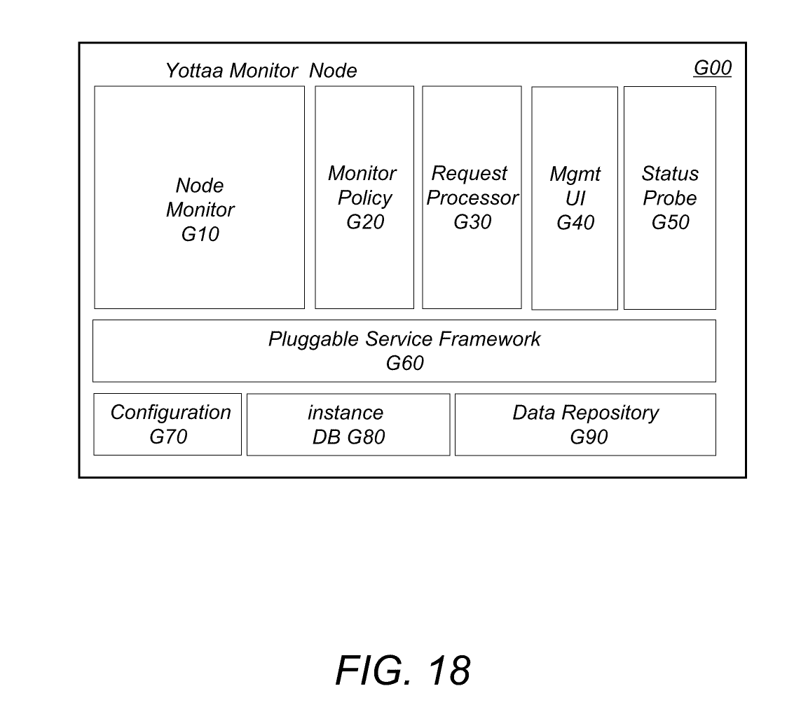

FIG. 19 shows an example of using the present invention to provide global geographic load balancing; and

FIG. 20 shows an example of using the present invention to provide improved web performance service over the Internet to web site operators;

### DETAILED DESCRIPTION OF THE INVENTION

The present invention utilizes an overlay virtual network to provide traffic management and load balancing for networked computer services that have multiple replicated instances running on different servers in the same data center or in different data centers.

Traffic processing nodes are deployed on the physical network through which client traffic travels to data centers where a network application is running. These traffic processing nodes are called “Traffic Processing Units” (TPU). TPUs are deployed at different locations, with each location forming a computing cloud. All the TPUs together form a “virtual network”, referred to as a “cloud routing network”. A traffic management mechanism intercepts all client traffic directed to the network application and redirects it to the TPUs. The TPUs perform load balancing and direct the traffic to an appropriate server that runs the network application. Each TPU has a certain amount of bandwidth and processing capacity. These TPUs are connected to each other via the underlying network, forming a second virtual network. This virtual network possesses a certain amount of bandwidth and processing capacity by combing the bandwidth and processing capacities of all the TPUs. When traffic grows to a certain level, the virtual network starts up more TPUs as a way to increase its processing power as well as bandwidth capacity. When traffic level decreases to a certain threshold, the virtual network shuts down certain TPUs to reduce its processing and bandwidth capacity.

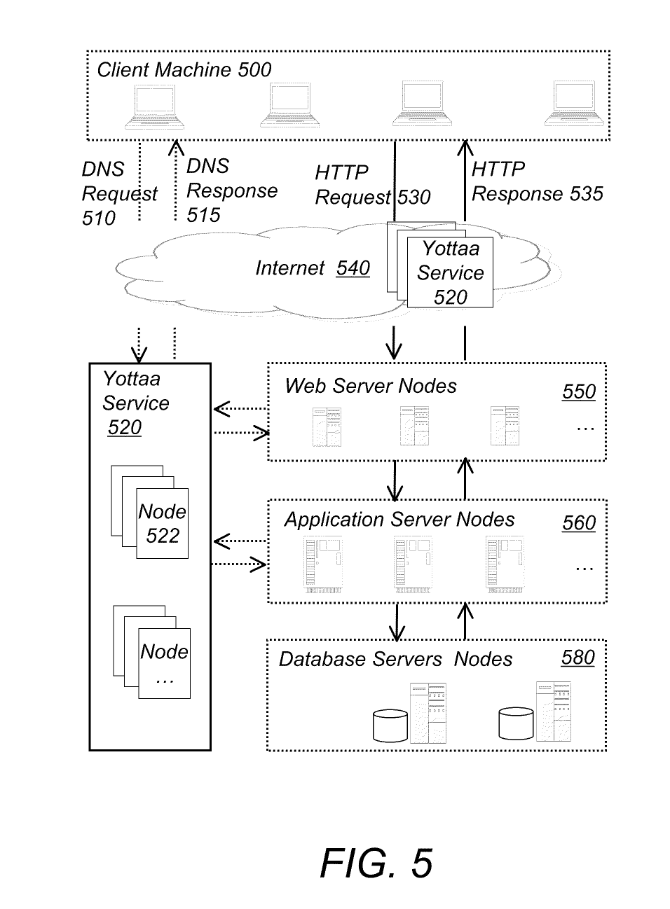

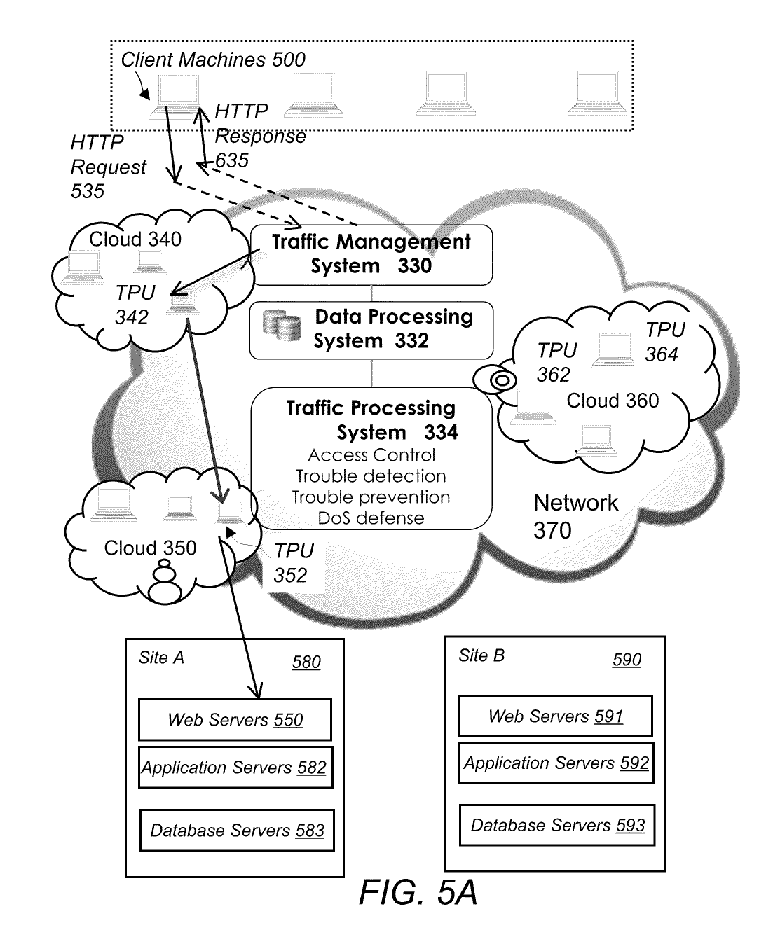

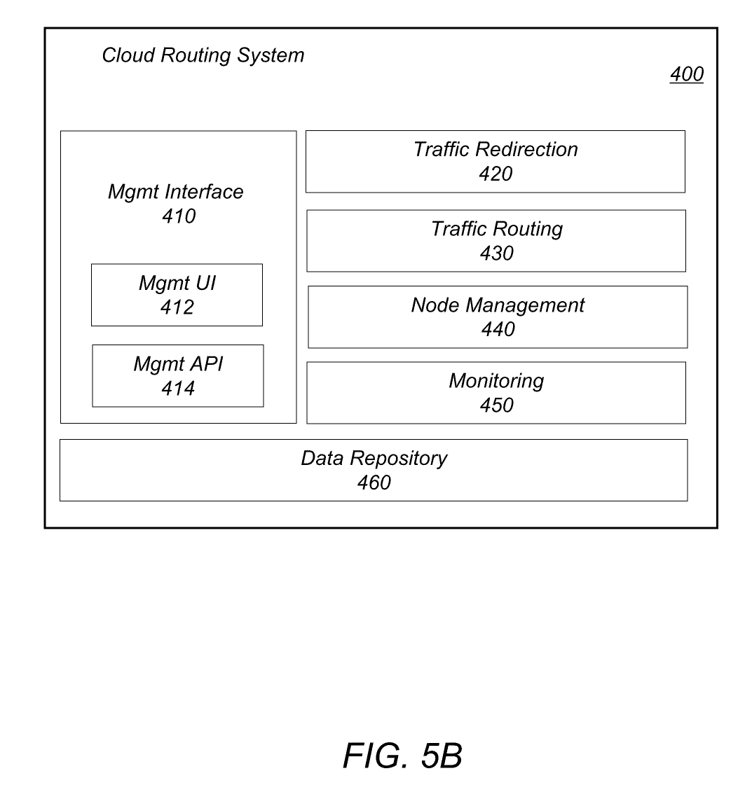

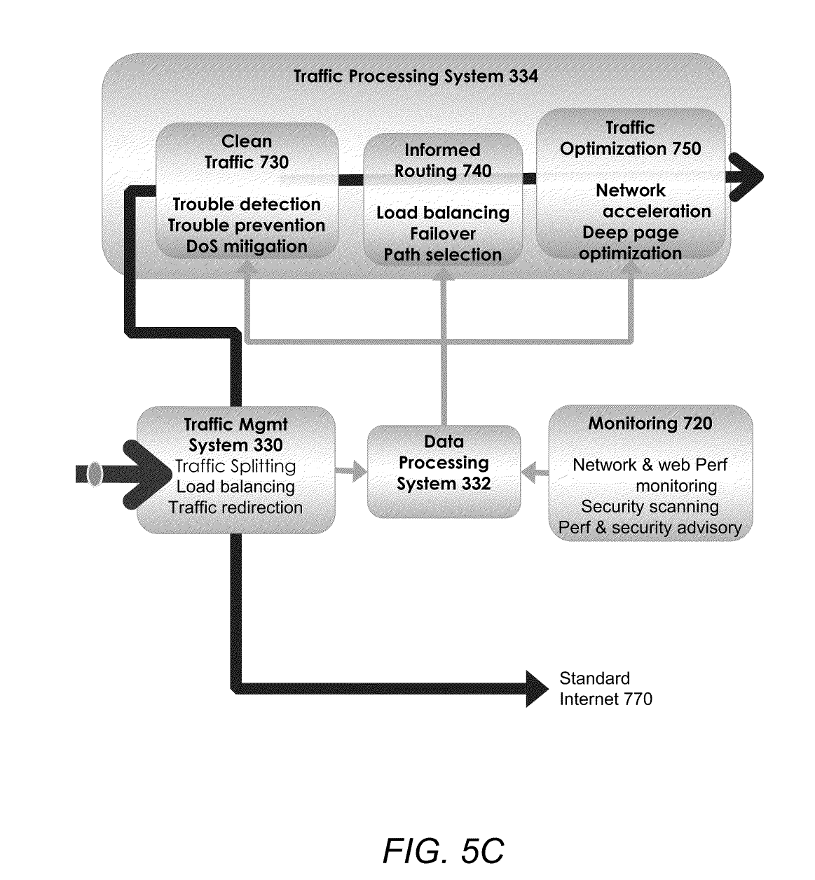

Referring to FIG. 5A, the virtual network includes nodes deployed at locations Cloud 340, Cloud 350 and Cloud 360. Each cloud includes nodes running specialized software for traffic management, traffic cleaning and related data processing. From a functional perspective, the virtual network includes a traffic management system 330 that intercepts and redirects network traffic, a traffic processing system 334 that perform access control, trouble detection, trouble prevention and denial of service (DOS) mitigation, and a global data processing system 332 that gathers data from different sources and provides global decision support. The networked computer service is running on multiple servers (i.e., servers 550 and servers 591) located in multiple sites (i.e., site A 580 and site B 590, respectively). Clients 500, access this network service via network 370.

A client 500 issues an HTTP request 535 to the network service in web server 550 in site A 580. The HTTP request 535 is intercepted by the traffic management system (TMS) 330. Instead of routing the request directly to the target servers 550, where the application is running (“Target Server”), traffic management system 330 redirects the request to an “optimal” traffic processing unit (TPU) 342 for processing. More specifically, as illustrated in FIG. 5A, traffic management system 330 consults global data processing system 332 and selects an “optimal” traffic processing unit 342 to route the request to. “Optimal” is defined by the specific application, as such being the closest geographically, being the closest in terms of network distance/latency, being the best performing node, being the cheapest node in terms of cost, or a combination of a few factors calculated according to a specific algorithm. The traffic processing unit 342 then inspects the HTTP request, perform the load balancing function and determines an “optimal” server for handling the HTTP request. The load balancing is performed by running a load balancing and failover algorithm. In some cases, the TPU routes the request to a target server directly. In other cases, the TPU routes the request to another traffic processing unit which may eventually route the request to target server, such as TPU 342 to TPU 352 and then to servers 550.

### Cloud Routing Network

The present invention leverages a cloud routing network. By way of background, we use the term “cloud routing network” to refer to a virtual network that includes traffic processing nodes deployed at various locations of an underlying physical network. These traffic processing nodes run specialized traffic handling software to perform functions such as traffic re-direction, traffic splitting, load balancing, traffic inspection, traffic cleansing, traffic optimization, route selection, route optimization, among others. A typical configuration of such nodes includes virtual machines at various cloud computing data centers. These cloud computing data centers provide the physical infrastructure to add or remove nodes dynamically, which further enables the virtual network to scale both its processing capacity and network bandwidth capacity. A cloud routing network contains a traffic management system 330 that redirects network traffic to its traffic processing units (TPU), a traffic processing mechanism 334 that inspects and processes the network traffic and a global data store 332 that gathers data from different sources and provides global decision support and means to configure and manage the system.

Most nodes are virtual machines running specialized traffic handling software. Each cloud itself is a collection of nodes located in the same data center (or the same geographic location). Some nodes perform traffic management. Some nodes perform traffic processing. Some nodes perform monitoring and data processing. Some nodes perform management functions to adjust the virtual network's capacity. Some nodes perform access management and security control. These nodes are connected to each other via the underlying network 370. The connection between two nodes may contain many physical links and hops in the underlying network, but these links and hops together form a conceptual “virtual link” that conceptually connects these two nodes directly. All these virtual links together form the virtual network. Each node has only a fixed amount of bandwidth and processing capacity. The capacity of this virtual network is the sum of the capacity of all nodes, and thus a cloud routing network has only a fixed amount of processing and network capacity at any given moment. This fixed account of capacity may be insufficient or excessive for the traffic demand. By adjusting the capacity of individual nodes or by adding or removing nodes, the virtual network is able to adjust its processing power as well as its bandwidth capacity.

Referring to FIG. 5B, the functional components of the cloud routing system 400 include a Traffic management interface unit 410, a traffic redirection unit 420, a traffic routing unit 430, a node management unit 440, a monitoring unit 450 and a data repository 460. The traffic management interface unit 410 includes a management user interface (UI) 412 and a management API 414.

### Traffic Processing

The invention uses a network service to process traffic and thus delivers only “conditioned” traffic to the target servers. FIG. 5A shows a typical traffic processing service. When a client 500 issues a request to a network service running on servers 550, 591, a cloud routing network processes the request in the following steps:
1. Traffic management service 330 intercepts the requests and routes the request to a TPU node 340, 350, 360;
2. The TPU node checks application specific policy and performs the pipeline processing shown in FIG. 5C.
3. If necessary, a global data repository is used for data collection and data analysis for decision support;
4. If necessary, the client request is routed to the next TPU node, i.e., from TPU 342 to 352; and then
5. Request is sent to an “optimal” server 381 for processing

More specifically, when a client issues a request to a server (for example, a consumer enters a web URL into a web browser to access a web site), the default Internet routing mechanism would route the request through the network hops along a certain network path from the client to the target server (“default path”). Using a cloud routing network, if there are multiple server nodes, the cloud routing network first selects an “optimal” server node from the multiple server nodes as the target serve node to serve the request. This server node selection process takes into consideration factors including load balancing, performance, cost, and geographic proximity, among others. Secondly, instead of going through the default path, the traffic management service redirects the request to an “optimal” Traffic Processing Unit (TPU) within the overlay network “Optimal” is defined by the system's routing policy, such as being geographically nearest, most cost effective, or a combination of a few factors. This “optimal” TPU further routes the request to second “optimal” TPU within the cloud routing network if necessary. For performance and reliability reasons, these two TPU nodes communicate with each other using either the best available or an optimized transport mechanism. Then the second “optimal” node may route the request to a third “optimal” node and so on. This process can be repeated within the cloud routing network until the request finally arrives at the target server. The set of “optimal” TPU nodes together form a “virtual” path along which traffic travels. This virtual path is chosen in such a way that a certain routing measure, such as performance, cost, carbon footprint, or a combination of a few factors, is optimized. When the server responds, the response goes through a similar pipeline process within the cloud routing network until it reaches the client.

### Process Scaling and Network Scaling

The invention also uses the virtual network for performing process scaling and bandwidth scaling in response to traffic demand variations.

The cloud routing network monitors traffic demand, load conditions, network performance and various other factors via its monitoring service. When certain conditions are met, it dynamically launches new nodes at appropriate locations and spreads load to these new nodes in response to increased demand, or shuts down some existing nodes in response to decreased traffic demand. The net result is that the cloud routing network dynamically adjusts its processing and network capacity to deliver optimal results while eliminating unnecessary capacity waste and carbon footprint.

Further, the cloud routing network can quickly recover from “fault”. When a fault such as node failure and link failure occurs, the system detects the problem and recovers from it by either starting a new node or selecting an alternative route. As a result, though individual components may not be reliable, the overall system is highly reliable.

### Traffic Redirection

The present invention includes a mechanism, referred to as “traffic redirection”, which intercepts client requests and redirects them to traffic processing nodes. The following list includes a few examples of the traffic interception and redirection mechanisms. However, this list is not intended to be exhaustive. The invention intends to accommodate various traffic redirection means.
1. Proxy server settings: most clients support a feature called “proxy server setting” that allows the client to specify a proxy server for relaying traffic to target servers. When a proxy server is configured, all client requests are sent to the proxy server, which then relays the traffic between the target server and the client.
2. DNS redirection: when a client tries to access a network service via its hostname, the hostname needs to be resolved into an IP address. This hostname to IP address resolution is achieved by using Domain Name Server (DNS) system. DNS redirection can provides a transparent way for traffic interception and redirection by implementing a customized DNS system that resolves a client's hostname resolution request to the IP address of an appropriate traffic processing node, instead of the IP address of the target server node.
3. HTTP redirection: there is a “redirect” directive built into the HTTP protocol that allows a server to tell the client to send the request to a different server.
4. Network address mapping: a specialized device can be configured to “redirect” traffic targeted at a certain destination to a different destination. This feature is supported by a variety of appliances (such as network gateway devices) and software products. One can configure such devices to perform the traffic redirection function.

### Monitoring

A cloud routing network contains a monitoring service 720 that provides the necessary data to the cloud routing network as the basis for operations, shown in FIG. 5C. Various embodiments implement a variety of techniques for monitoring. The following lists a few examples of monitoring techniques:
1. Internet Control Message Protocol (ICMP) Ping: A small IP packet that is sent over the network to detect route and node status;
2. traceroute: a technique commonly used to check network route conditions;
3. Host agent: an embedded agent running on host computers that collects data about the host;
4. Web performance monitoring: a monitor node, acting as a normal user agent, periodically sends HTTP requests to a web server and processes the HTTP responses from the web server. The monitor nodes record metrics along the way, such as DNS resolution time, request time, response time, page load time, number of requests, number of JavaScript files, or page footprint, among others.
5. Security monitoring: A monitor node periodically scans a target system for security vulnerabilities such as network port scanning and network service scanning to determine which ports are publicly accessible and which network services are running and further determines whether there are vulnerabilities.
6. Content security monitoring: a monitor nodes periodically crawls a web site and scans its content for detection of infected content, such as malware, spyware, undesirable adult content, or virus, among others.

The above examples are for illustration purpose. The present invention is agnostic and accommodates a wide variety of ways of monitoring. Embodiments of the present invention may employ one or combinations of the above mentioned techniques for monitoring different target systems, i.e., using ICMP, traceroute and host agent to monitor the cloud routing network itself, using web performance monitoring, network security monitoring and content security monitoring to monitor the available, performance and security of target network services such as web applications. A data processing system (DPS) aggregates data from such monitoring service and provides all other services global visibility to such data.

### Examples of Load Balancing and Traffic Management

In the following description, the term “Yottaa Service” refers to a system that implements the subject invention for traffic management and load balancing.

FIG. 5 depicts an example of load balancing of traffic from clients to multiple replicated web application instances running on different servers housed in the same data center. Referring to FIG. 5, the traffic redirection mechanism utilizes a DNS redirection mechanism. In order to access web server 550, client machine 500 needs to resolve the IP address of the web server 550 first. Client 500 sends out a DNS request 510, and Yottaa service 520 replies with a DNS response 515. DNS response 515 resolves the domain name of HTTP request 530 to a traffic processing node running within Yottaa service 520. As a result, HTTP request 530 to a web server 550 is redirected to a traffic processing node within Yottaa service 520. This node further forwards the request to one of the web servers in web server farm 550 and eventually the request is processed. Likewise, web server nodes 550 and application servers 560 in the data center may also use the Yottaa service 520 to access their communication targets.

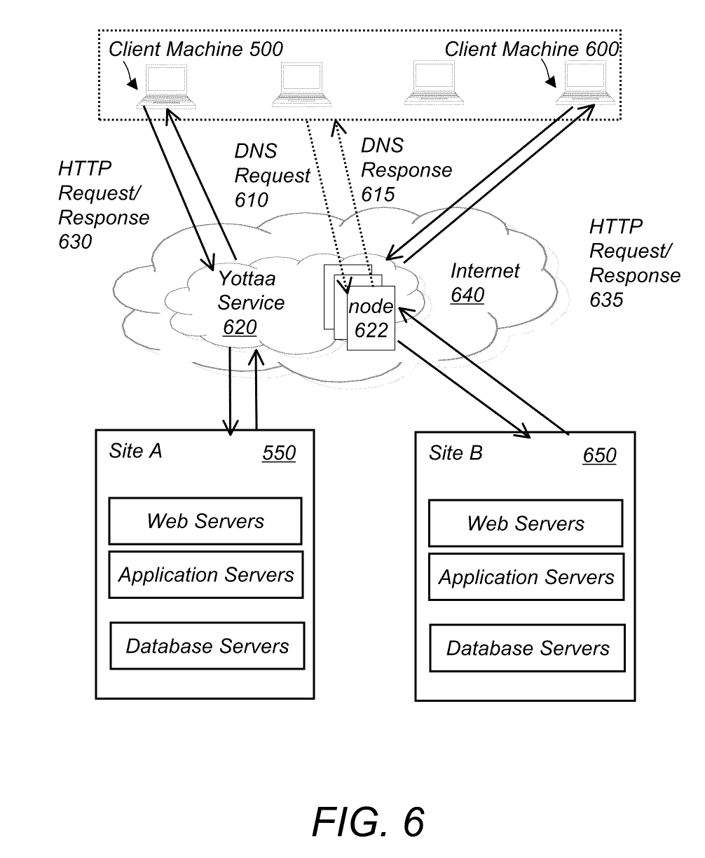

FIG. 6 depicts an example of Yottaa service 620 redirecting and load balancing of traffic from clients 500, 600 to multiple replicated web application instances running on different servers housed in different data centers 550, 650.

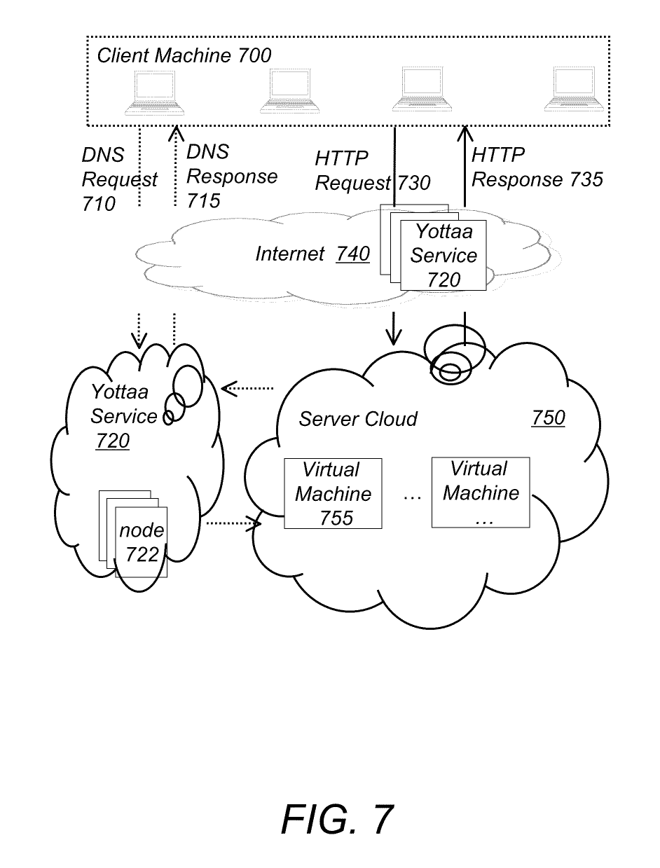

FIG. 7 depicts an example of Yottaa service 720 redirecting and load balancing of traffic from clients 700 to multiple replicated web application instances running on “virtual machine” (VM) nodes 755 in a cloud computing environment 750. When client machine 700 requests service provided by cloud 750, Yottaa service 720 selects the most appropriate virtual machine node within the cloud to serve the request.

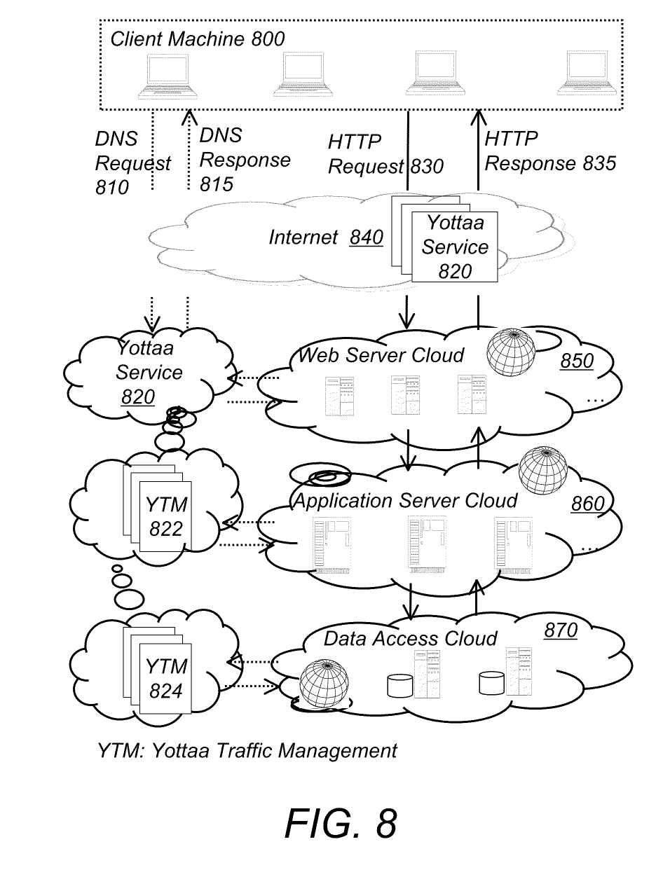

FIG. 8 depicts an example of Yottaa service 820 redirecting and load balancing of traffic from clients 800 to a 3-tiered web application running in a cloud computing environment. Each tier (web server 850, application server 860, database server 870) contains multiple VM instances.

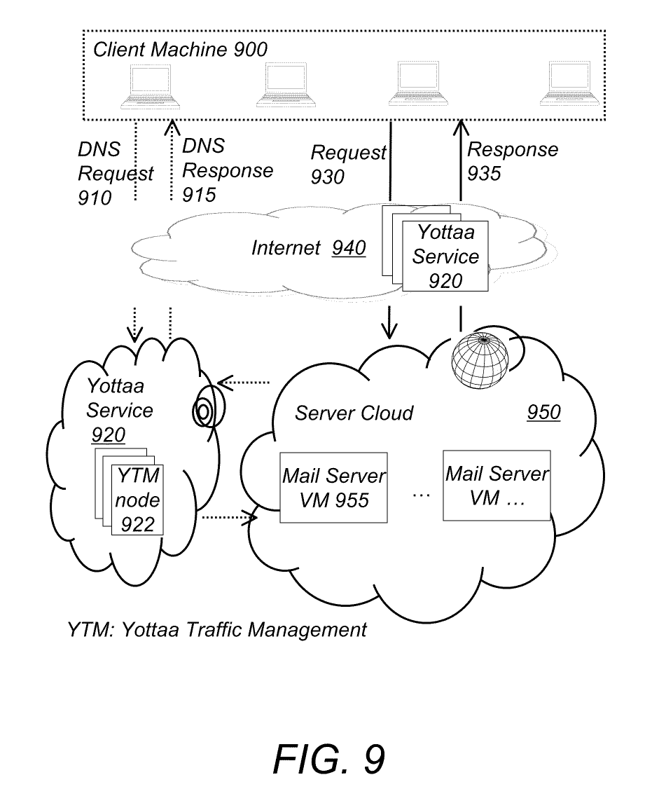

FIG. 9 depicts an example of Yottaa service 920 redirecting and load balancing of traffic from clients 900 to mail servers 955 in a multi-server environment. The mail servers may run as VM nodes in a computing cloud 950.

The present invention uses a Domain Name System (DNS) to achieve traffic redirection by providing an Internet Protocol (IP) address of a desired processing node in a DNS hostname query. As a result, client requests are redirected to the desired processing node, which then routes the requests to the target computing node for processing. Such a technique can be used in any situation where the client requires access to a replicated network resource. It directs the client request to an appropriate replica so that the route to the replica is good from a performance standpoint. Further, the present invention also takes session stickiness into consideration. Requests from the same client session are routed to the same server computing node persistently when session stickiness is required. Session stickiness, also known as “IP address persistence” or “server affinity” in the art, means that different requests from the same client session will always to be routed to the same server in a multi-server environment. “Session stickiness” is required for a variety of web applications to function correctly.

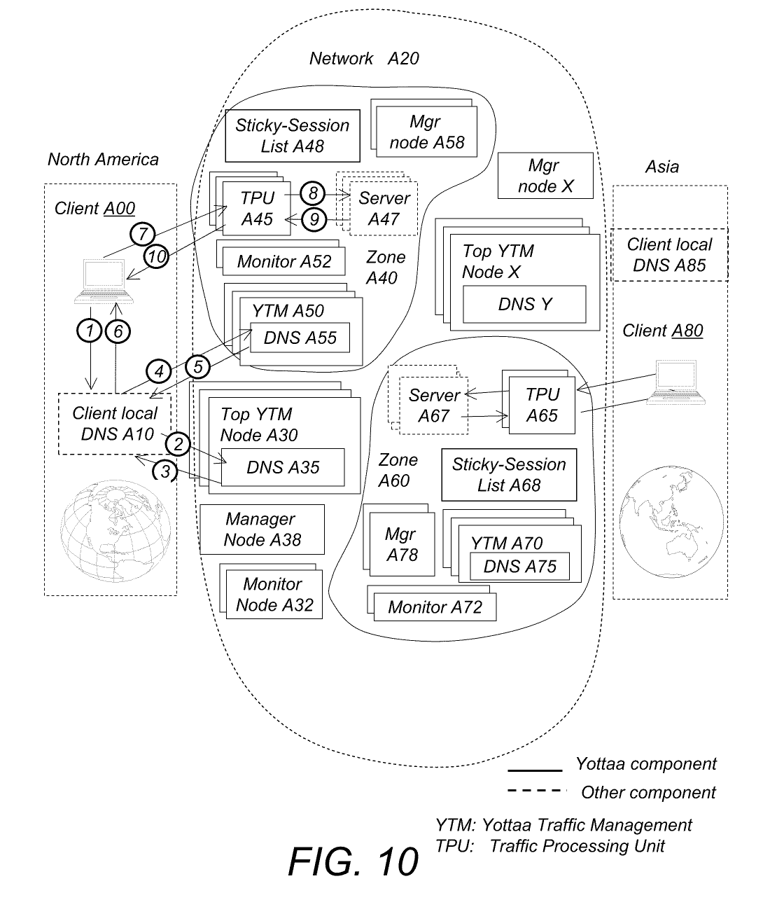

The technical details of the present invention are better understood by examining an embodiment of the invention named “Yottaa”, shown in FIG. 10. Yottaa contains functional components including Traffic Processing Unit (TPU) nodes A45, A65, Yottaa Traffic Management (YTM) nodes A30, A50, A70, Yottaa Manager nodes A38, A58, A78 and Yottaa Monitor nodes A32, A52, A72. In this example, the computing service is running on a variety of server computing nodes such as Server A47 and A67 in a network computing environment A20. The system contains multiple YTM nodes, which together are responsible for redirecting traffic from client machines to the list of server computing nodes in network A20. Each YTM node contains a DNS module. The top level YTM nodes and lower level YTM nodes together form a hierarchical DNS tree that resolves hostnames to appropriate IP addresses of selected “optimal” TPU nodes by taking factors such as node load conditions, geographic proximity and network performance into consideration. Further, each TPU node selects an “optimal” server computing node to which it forwards the client requests. The “optimal” server computing node is selected based on considering factors such as node availability, performance and session stickiness (if required). As a result, client requests are load balanced among the list of server computing nodes, with real time failover protection should some server computing nodes fail.

Referring to FIG. 10, the workflow of directing a client request to a particular server node using the present invention includes the following step.

1: A client A00 sends a request to a local DNS server to resolve a host name for server running a computer service (1). If the local DNS server cannot resolve the host name it forwards it to a top YTM node A30 (2). Top YTM node A30 receives a request from a client DNS server A10 to resolve the host name.

2: The top YTM node A30 selects a list of lower level YTM nodes and returns their addresses to the client DNS server A10 (3). The size of the list is typically 3 to 5 and the top level YTM tries to make sure the returned list spans across two different data centers if possible. The selection of the lower level YTM is decided according to a repeatable routing policy. When a top YTM replies to a DNS lookup request, it sets a long Time-To-Live (TTL) value according to the routing policy (for example, a day, a few days or even longer).

3. The client DNS server A10 in turn queries the returned lower level YTM node A50 for name resolution of the host name (4). Lower level YTM node A50 utilizes data gathered by monitor node A52 to select an “optimal” TPU node and returns the IP address of this TPU node to client DNS server A10 (5).

4. The client A00 then sends the request to TPU A45 (7). When the selected TPU node A45 receives a client request, it first checks to see if session stickiness support is required. If session stickiness is required, it checks to see if a previously selected server computing node exists from an earlier request by consulting a sticky-session table A48. This searching only needs to be done in the local zone. If a previously selected server computing node exists, this server computing node is returned immediately. If a previously selected server computing node doe not exists, the TPU node selects an “optimal” server computing node A47 according to specific load balancing and failover policies (8). Further, if the application requires session stickiness, the selected server computing node and the client are added to sticky-session table A48 for future reference purpose. The server A47 then processes the request and sends a response back to the TPU A45 (9) and the TPU A45 sends it to the client A00(10).

The hierarchical structure of YTM DNS nodes combined with setting different TTL values and the loading balancing policies used in the traffic redirection and load balancing process result in achieving the goals of traffic management, i.e., performance acceleration, load balancing, and failover. The DNS-based approach in this embodiment is just an example of how traffic management can be implemented, and it does not limit the present invention to this particular implementation in any way.

One aspect of the present invention is that it is fault tolerant and highly responsive to node status changes. When a lower level YTM node starts up, it finds a list of top level YTM from its configuration data and automatically notifies them about its availability. As a result, top level YTM nodes add this new node to the list of nodes that receive DNS requests. When a lower level YTM down notification event is received from a manager node, a top level YTM node takes the down node off its lists. Because multiple YTM nodes are returned to a DNS query request, one YTM node going down will not result in DNS query failures. Further, because of the short TTL value returned from lower level YTM nodes, a server node failure would be transparent to any user. If sticky-session support is required, these users who are currently connected to this failed server node may get an error. However, even for these users, it will be able to recover shortly after the TTL expires. When a manager node detects a server node failure, it notifies the lower level YTM nodes in the local zone and these YTM nodes immediately take this server node off the routing list. Further, if some of the top nodes are down, most DNS query will not notice the failure because of the long TTL value returned by the top YTM nodes. Queries to the failed top level nodes after the TTL expiration will still be successful as long as at least one top level YTM node in the DNS record of the requested hostname is still running. When a server computing node is stopped or started, its status changes are detected immediately by the monitoring nodes. Such information enables the TPU nodes to make real time routing adjustments in response to node status changes.

Another aspect of the present invention is that it is highly efficient and scalable. Because the top YTM returns long TTL value and DNS servers over the Internet perform DNS caching, most of the DNS queries will go to lower level YTM nodes directly and therefore the actual load on the top level YTM nodes is fairly low. Further, the top level YTM nodes do not need to communicate with each other and therefore by adding new nodes to the system, the system's capacity increases linearly. Lower level YTM nodes do not need to communicate with each other either, as long as the sticky-session list is accessible in the local zone. When a new YTM node is added, it only needs to communicate with a few top YTM nodes and a few manager nodes, and the capacity increases linearly as well.

In particular, FIG. 10 shows the architecture of Yottaa service and the steps in resolving a request from client machine A00 located in North America to its closest server instance A47. Similarly, requests from client machine A80 located in Asia are directed to server A67 that is close to A80. If the application requires sticky session support, the system uses a sticky-session list to route requests from the same client session to a persistent server computing node.

The system “Yottaa” is deployed on network A20. The network can be a local area network, a wireless network, a wide area network such as the Internet, etc. The application is running on nodes labeled as “server” in the figure, such as server A47 and server A67. Yottaa divides all these server instances into different zones, often according to geographic proximity or network proximity. Each YTM node manages a list of server nodes. For example, YTM node A50 manages servers in Zone A40, such as server A47. Over the network, Yottaa deploys several types of logical nodes including TPU nodes A45, A65, Yottaa Traffic Management (YTM) nodes, such as A30, A50, and A70, Yottaa manager nodes, such as A38, A58 and A78 and Yottaa monitor nodes, such as A32, A52 and A72. Note that these three types of logical nodes are not required to be separated into three entities in actual implementation. Two of them, or all of them, can be combined into the same physical node in actual deployment.

There are two types of YTM nodes: top level YTM node (such as A30) and lower level YTM node (such as A50 and A70). They are identical structurally but function differently. Whether a YTM node is a top level node or a lower level node is specified by the node's own configuration. Each YTM node contains a DNS module. For example, YTM A50 contains DNS A55. Further, if a hostname requires sticky-session support (as specified by web operators), a Sticky-session list (such as A48 and A68) is created for the hostname of each application. This sticky session list is shared by YTM nodes that manage the same list of server nodes for this application. In some sense, top level YTM nodes provide services to lower level YTM nodes by directing DNS requests to them. In a cascading fashion, each lower level YTM node provides similar services to its own set of “lower” level YTM nodes, similar to a DNS tree in a typical DNS topology. Using such a cascading tree structure, the system prevents a node from being overwhelmed with too many requests, guarantees the performance of each node and is able to scale up to cover the entire Internet by just adding more nodes.

FIG. 10 shows architecturally how a client in one geographic region is directed to a “closest” server node. The meaning of “closest” is determined by the system's routing policy for the specific application. When client A00 wants to connect to a server, the following steps happen in resolving the client DNS request:
1. Client A00 sends a DNS lookup request to its local DNS server A10;
2. Local DNS server A10 (if it can not resolve the request directly) sends a request to a top level YTM A30 (actually, the DNS module A35 running inside A30). The selection of YTM A30 is based on system configuration i.e., YTM A30 is configured in the DNS record for the requested hostname;
3. Upon receiving the request from A10, top YTM A30 returns a list of lower level YTM nodes to A10. The list is chosen according to the current routing policy, such as selecting YTM nodes that are geographically closest to client local DNS A10;
4. A10 receives the response, and sends the hostname resolution request to one of the returned lower level YTM nodes, A50;
5. Lower level YTM node A50 receives the request, returns a list of IP addresses of “optimal” TPU nodes according to its routing policy. In this case, TPU node A45 is chosen and returned because it is geographically closest to the client DNS A10;
6. A10 returns the received list of IP addresses to client A00;
7. A00 sends its requests to TPU node A45;
8. TPU node A45 receives a request from client A00 and selects an “optimal” server node to forward the request to, such as server A47.
9. Server A47 receives the forwarded request, processes it and returns a response.
10. TPU node A45 sends the response to the client A00.

Similarly, client A80 who is located in Asia is routed to server A65 instead.

Yottaa service provides a web-based user interface (UI) for web operators to configure the system in order to employ Yottaa service for their web applications. Web operators can also use other means such as network-based Application Programming Interface (API) calls or modifying configuration files directly by the service provider. Using Yottaa Web UI as an example, a web operator performs the following steps.
1. Enter the hostname of the target web application, for example, www.yottaa.com;
2. Enter the IP addresses of the server computing nodes that the target web application is running on (if there are servers that the web application has already been deployed to directly by the Web operator);
3. Configure whether Yottaa should launch new server instances in response to traffic demand increase and the associated configuration parameters. Also, whether Yottaa should shutdown server nodes if capacity exceeds demand by a certain threshold;
4. Add the supplied top level Yottaa node names to the DNS record of the hostname of the target web application;
5. Configure other parameters such as whether the application requires sticky-session support, session expiration value, routing policy, and so on.

Once Yottaa system receives the above information, it performs necessary actions to set up its service to optimize traffic load balancing of the target web application. For example, upon receiving the hostname and static IP addresses of the target server nodes, the system propagates such information to selected lower level YTM nodes (using the current routing policy) so that at least some lower level YTM nodes can resolve the hostname to IP address(s) when a DNS lookup request is received.

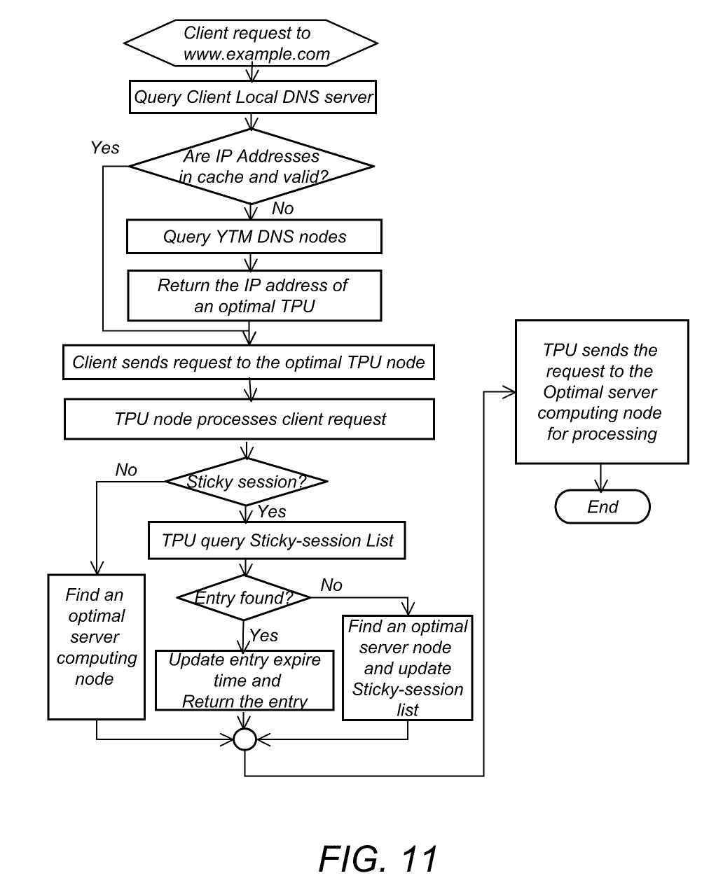

FIG. 11 shows a process workflow of how a request is routed using the Yottaa service. When a client wants to connect to a host, i.e., www.example.com, it needs to resolve the IP address of the hostname first. To do so, it queries its local DNS server. The local DNS server first checks whether such hostname is cached and still valid from a previous resolution. If so, the cached result is returned. If not, client DNS server issues a request to the pre-configured DNS server for www.example.com, which is a top level YTM node. The top level YTM node returns a list of lower level YTM nodes according to a repeatable routing policy configured for this application. Upon receiving the returned list of YTM DNS nodes, client DNS server needs to query these nodes until a resolved IP address is received. So it sends a request to one of the lower level YTM nodes in the list. The lower level YTM receives the request, and then it selects a list of “optimal” TPU nodes based on the current routing policy and node monitoring status information. The IP addresses of the selected “optimal” TPU nodes are returned. As a result, the client sends a request to one of the “optimal” TPU nodes. The selected “optimal” TPU node receives the request. First, it figures out whether this application requires sticky-session support. Whether an application requires sticky-session support is typically configured by the web operator during the initial setup of the subscribed Yottaa service. This initial change can be changed later. If sticky-session support is not required, the TPU node selects an “optimal” server computing node that is running application www.example.com, chosen according to the current routing policy and server computing node monitoring data. If sticky-session support is required, the TPU node first looks for an entry in the sticky-session list using the hostname or URL (in this case, www.example.com) and the IP address of the client as the key. If such an entry is found, the expiration time of this entry in the sticky-session list is updated to be the current time plus the pre-configured session expiration value. When a web operator performs initial configuration of Yottaa service, he enters a session expiration timeout value into the system, such as one hour. If no entry is found, the TPU node picks an “optimal” server computing node according to the current routing policy, creates an entry with the proper key and expiration information, and inserts this entry into the sticky-session list. Finally, the TPU node forwards the client request to the selected “optimal” server computing node for processing. If an error is received during the process of querying a lower level YTM node, the client DNS server will query the next TPU node in the list. So the failure of an individual lower level YTM node is invisible to the client. Likewise, if there is an error connecting to the IP address of one of the returned “optimal” TPU nodes, the client will try to connect to the next IP address in the list, until a connection is successfully made.

Top YTM nodes typically set a long Time-To-Live (TTL) value for its returned results. Doing so minimizes the load on top level nodes as well as reduces the number of queries from the client DNS server. On the other side, lower YTM nodes typically set a short TTL value, making the system very responsive to TPU node status changes.

The sticky-session list is periodically cleaned up by purging the expired entries. An entry expires when there is no client request for the same application from the same client during the entire session expiration duration since the last lookup. During a sticky-session scenario, if the server node of a persistent IP address goes down, a Yottaa monitor node detects the server failure and notifies its associated manager nodes. The associated manager nodes notify the corresponding YTM nodes. These YTM nodes then remove the entry from the sticky-session list. The TPU nodes will automatically forward traffic to different server nodes going forward. Further, for sticky-session scenarios, Yottaa manages server node shutdown intelligently so as to eliminate service interruption for these users who are connected to the server node planned for shutdown. It waits until all user sessions on this server node have expired before finally shutting down the node instance.

Yottaa leverages the inherit scalability designed into the Internet's DNS system. It also provides multiple levels of redundancy in every step (except for sticky-session scenarios where a DNS lookup requires a persistent IP address). Further, the system uses a multi-tiered DNS hierarchy so that it naturally spreads loads onto different YTM nodes to efficiently distribute load and be highly scalable, while being able to adjust the TTL value for different nodes and be responsive to node status changes.

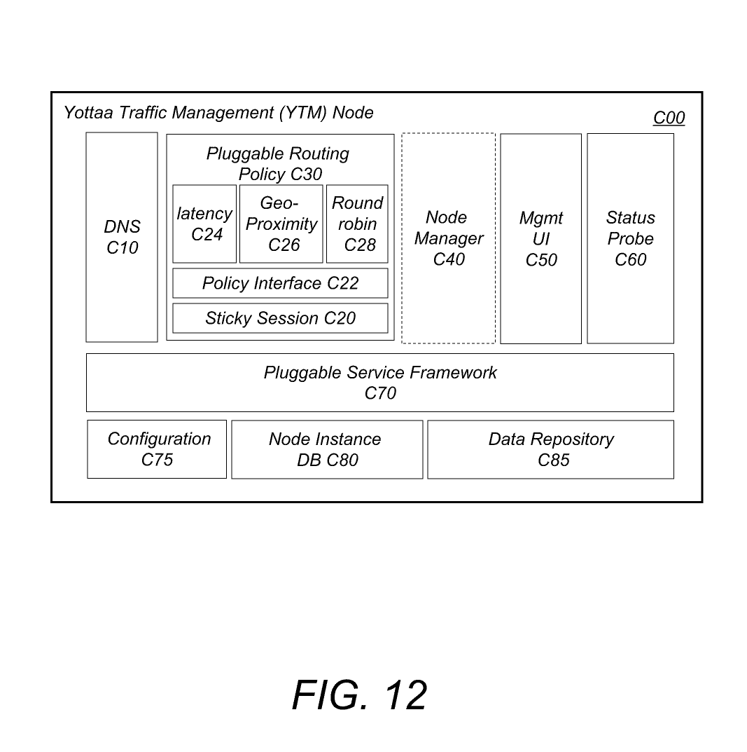

FIG. 12 shows the functional blocks of a Yottaa Traffic Management node, shown as COO in the diagram. The node contains DNS module C10 that perform standard DNS functions, status probe module C60 that monitors status of this YTM node itself and responds to status inquires, management UI module C50 that enables system administrators to manage this node directly when necessary, virtual machine manager C40 (optional) that can manage virtual machine nodes over a network and a routing policy module C30 that manages routing policy. The routing policy module can load different routing policy as necessary. Part of module C30 is an interface for routing policy and another part of this module provide sticky-session support during a DNS lookup process. Further, YTM node COO contains configuration module C75, node instance DB C80, and data repository module C85.

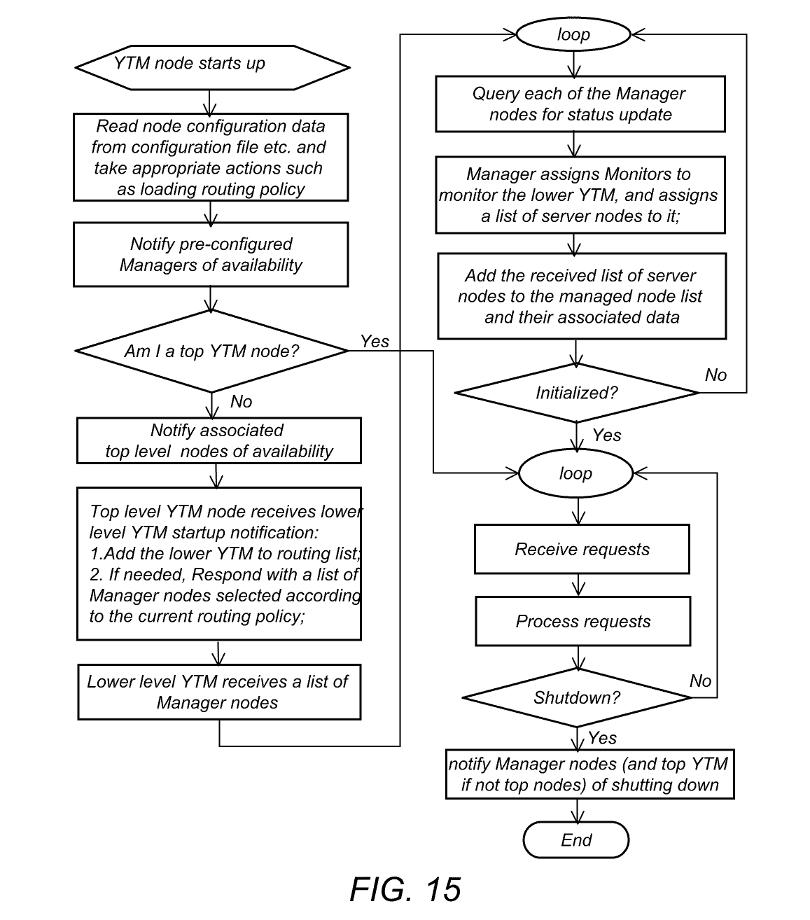

FIG. 15 shows how a YTM node works. When a YTM node boots up, it reads initialization parameters from its environment, its configuration file, instance DB and so on. During this process, it takes proper actions as necessary, such as loading a specific routing policy for different applications. Further, if there are manager nodes specified in the initialization parameters, the YTM node sends a startup availability event to such manager nodes. Consequentially, these manager nodes propagate a list of server nodes to this YTM node and assign monitor nodes to monitor the status of the YTM node. Next, the YTM node checks to see if it is a top level YTM according to its configuration parameters. If it is a top level YTM, the node enters its main loop of request processing until eventually a shutdown request is received or a node failure happens. Upon receiving a shutdown command, the node notifies its associated manager nodes of the shutdown event, logs the event and then performs shutdown. If the node is not a top level YTM node, it continues its initialization by sending a startup availability event to a designated list of top level YTM nodes as specified in the node's configuration data.

When a top level YTM node receives a startup availability event from a lower level YTM node, it performs the following actions:
1. Adds the lower level YTM node to the routing list so that future DNS requests may be routed to this lower level YTM node;
2. If the lower level YTM node does not have associated manager node set up already (as indicated by the startup availability event message), selects a list of manager nodes according to the top level YTM node's own routing policy, and returns this list of manager nodes to the lower level YTM node.

When a lower level YTM node receives the list of manager nodes from a top level YTM node, it continues its initialization by sending a startup availability event to each manager node in the list for status update. When a manager node receives a startup availability event from a lower level YTM node, it assigns monitor nodes to monitor the status of the YTM node. Further, the manager node returns the list of server nodes that is under management by this manager (actual monitoring is carried out by the manager's associated monitor nodes) to the YTM node. When the lower level YTM node receives a list of server nodes from a manager node, the information is added to the managed server node list that this YTM node manages so that future DNS requests maybe routed to servers in the list.

After the YTM node completes setting up its managed server node list, it enters its main loop for request processing. For example:
If a DNS request is received, the YTM node returns one or more nodes from its managed node list according to the routing policy for the target hostname and client DNS server.
If the request is a node down event from a manager node, the node is removed from the managed node list.
If a node startup event is received, the new node is added to the managed node list.

Finally, if a shutdown request is received, the YTM node notifies its associated manager nodes as well as the top level YTM nodes of its shutdown, saves the necessary state into its local storage, logs the event and shuts down.

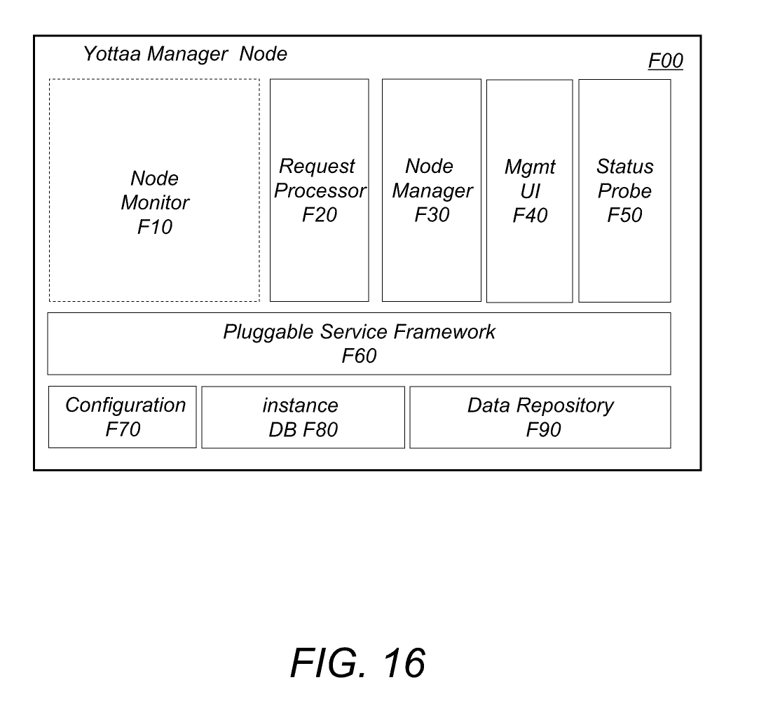

FIG. 16 shows functional blocks of a Yottaa Manager node. It contains a request processor module F20 that processes requests received from other Yottaa nodes over the network, a Virtual Machine (VM) manager module F30 that can be used to manage virtual machine instances, a management user interface (UI) module F40 that can be used to configure the node locally, and a status probe module F50 that monitors the status of this node itself and responds to status inquires. Optionally, if a monitor node is combined into this node, the manager node then also contains node monitor module F10 that maintains the list of nodes to be monitored and periodically polls nodes in the list according to the current monitoring policy.

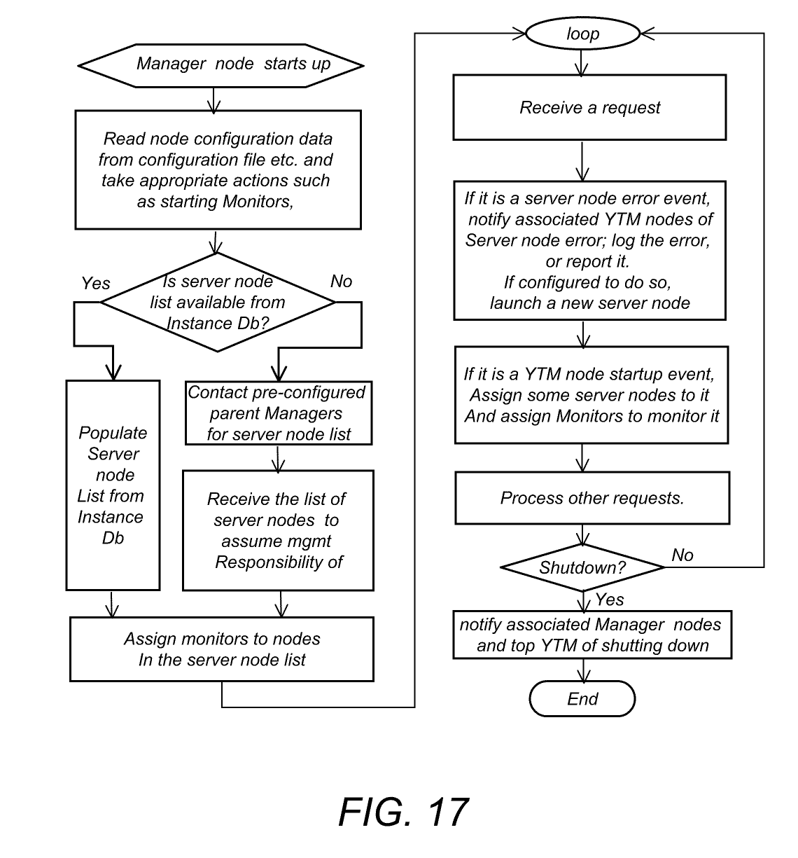

FIG. 17 shows how a Yottaa manager node works. When it starts up, it reads configuration data and initialization parameters from its environment, configuration file, instance DB and so on. Proper actions are taken during the process. Then it sends a startup availability event to a list of parent manager nodes as specified from its configuration data or initialization parameters.

When a parent manager node receives the startup availability event, it adds this new node to its list of nodes under “management”, and “assigns” some associated monitor nodes to monitor the status of this new node by sending a corresponding request to these monitor nodes. Then the parent manager node delegates the management responsibilities of some server nodes to the new manager node by responding with a list of such server nodes. When the child Manager node receives a list of server nodes of which it is expected to assume management responsibility, it assigns some of its associated monitor nodes to do status polling and performance monitoring of the list of server nodes. If no parent manager node is specified, the Yottaa manager is expected to create its list of server nodes from its configuration data. Next, the manager node finishes its initialization and enters its main processing loop of request processing.

If the request is a startup availability event from a YTM node, it adds this YTM node to the monitoring list and replies with the list of server nodes for which the YTM node is assigned to do traffic management. Note that, in general, the same server node can be assigned to multiple YTM nodes for routing. If the request is a shutdown request, it notifies its parent manager nodes of the shutdown, logs the event, and then performs shutdown. If a node error request is reported from a monitor node, the manager node removes the error node from its list (or move it to a different list), logs the event, and optionally reports the event. If the error node is a server node, the manager node notifies the associated YTM nodes of the server node loss, and if configured to do so and certain conditions are met, it attempts to re-start the node or launch a new server node.

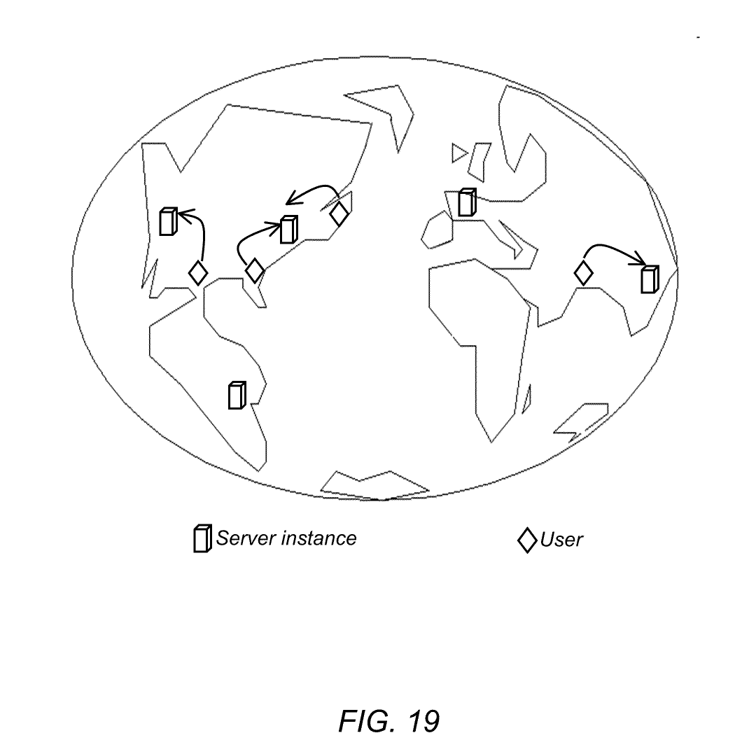

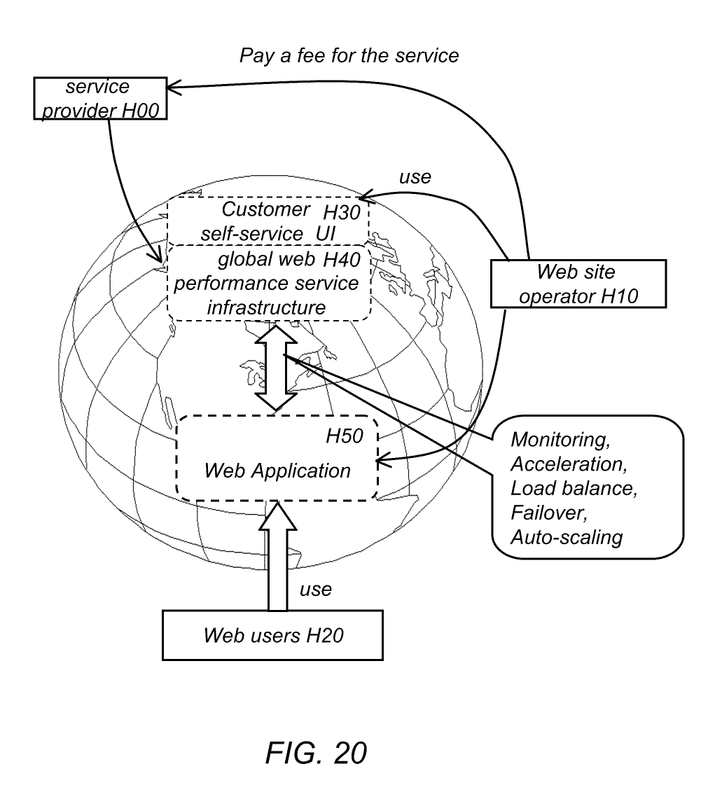

One application of the present invention is to provide an on-demand service delivered over the Internet to web site operators to help them improve their web application performance, scalability and availability, as shown in FIG. 20. Service provider H00 manages and operates a global infrastructure H40 providing web performance related services, including monitoring, load balancing, traffic management, scaling and failover, etc. The global infrastructure also has a management and configuration user interface (UI) H30, as shown in FIG. 19, for customers to purchase, configure and manage services from the service provider. Customers include web operator H10, who owns and manages web application HSO. Web application HSO may be deployed in one data center, a few data centers, in one location, in multiple locations, or run as virtual machines in a distributed cloud computing environment. H40 provides services including monitoring, traffic management, load balancing, failover, etc to web application HSO with the result of delivering better performance, better scalability and better availability to web users H20. In return for using the service, web operator H10 pays a fee to service provider H00.

Content Delivery Networks typically employ thousands or even tens of thousands of servers globally, and require as many point of presence (POP) as possible. Different from that, the present invention needs to be deployed to only a few or a few dozens of locations. Further, servers whose traffic the present invention intends to manage are typically deployed in only a few data centers, or sometimes in one data center only.

Several embodiments of the present invention have been described. Nevertheless, it will be understood that various modifications may be made without departing from the spirit and scope of the invention. Accordingly, other embodiments are within the scope of the following claims.

What is claimed is:

1. A method for providing load balancing and failover among a set of computing nodes running a network accessible computer service, comprising:
providing a computer service wherein said computer service is hosted at one or more servers comprised in said set of computing nodes and is accessible to clients via a first network;
providing a second network comprising a plurality of traffic processing nodes and load balancing means and wherein said load balancing means is configured to provide load balancing among said set of computing nodes running said computer service;
providing means for redirecting network traffic comprising client requests to access said computer service from said first network to said second network;
providing means for selecting a traffic processing node of said second network for receiving said redirected network traffic comprising said client requests to access said computer service and redirecting said network traffic to said traffic processing node via said means for redirecting network traffic;
for every client request for access to said computer service determining an optimal computing node among said set of computing nodes running said computer service by said traffic processing node via said load balancing means; and
routing said client request to said optimal computing node by said traffic processing node via said second network.

2. The method of claim 1 wherein said load balancing means comprises a load balancing and failover algorithm.

3. The method of claim 1 wherein said second network comprises an overlay network superimposed over said first network.

4. The method of claim 1, wherein said traffic processing node inspects said redirected network traffic and routes all client requests originating from the same client session to the same optimal computing node.

5. The method of claim 1, wherein said network accessible computer service is accessed via a domain name within the first network and wherein said means for redirecting network traffic resolves said domain name of said network accessible computer service to an IP address of said traffic processing node of said second network.

6. The method of claim 1, wherein said network accessible computer service is accessed via a domain name within the first network and wherein said means for redirecting network traffic adds a CNAME to a Domain Name Service (DNS) record of said domain name of said network accessible computer service and resolves the CNAME to an IP address of said traffic processing node of said second network.

7. The method of claim 1, wherein said network accessible computer service is accessed via a domain name within the first network and wherein second network further comprises a domain name server (DNS) node and wherein said DNS node receives a client DNS query for said domain name and resolves said domain name of said network accessible computer service to an IP address of said traffic processing node of said second network.

8. The method of claim 1, wherein said traffic processing node is selected based on geographic proximity of said traffic processing node to the request originating client.

9. The method of claim 1, wherein said traffic processing node is selected based on metrics related to load conditions of said traffic processing nodes of said second network.

10. The method of claim 1, wherein said traffic processing node is selected based on metrics related to performance statistics of said traffic processing nodes of said second network.

11. The method of claim 1, wherein said traffic processing node is selected based on a sticky-session table mapping clients to said traffic processing nodes.

12. The method of claim 2, wherein said optimal computing node is determined based on said load balancing algorithm and wherein said load balancing algorithm utilizes one of optimal computing node performance, lowest computing cost, round robin or weighted traffic distribution computing criteria.

13. The method of claim 1, wherein said traffic processing nodes comprise virtual machines nodes.

14. The method of claim 1, wherein said second network comprises traffic processing nodes distributed at different geographic locations.

15. The method of claim 1, further comprising providing monitoring means for monitoring the status of said traffic processing nodes and said computing nodes.

16. The method of claim 15, wherein upon detection of a failed traffic processing node or a failed computing node, redirecting in real-time network traffic to a non-failed traffic processing node or routing client requests to a non-failed computing node, respectively.

17. The method of claim 15, wherein said optimal computing node is determined in real-time based on feedback from said monitoring means.

18. The method of claim 1, wherein said second network scales its processing capacity and network capacity in real-time by dynamically adjusting the number of traffic processing nodes.

19. The method of claim 1, wherein said computer service comprises one of a web application, web service or email service.

20. A system for providing load balancing and failover among a set of computing nodes running a network accessible computer service, comprising:
a first network providing network connections between a set of computing nodes and a plurality of clients
a computer service wherein said computer service is hosted at one or more servers comprised in said set of computing nodes and is accessible to clients via said first network;
a second network comprising a plurality of traffic processing nodes and load balancing means and wherein said load balancing means is configured to provide load balancing among said set of computing nodes running said computer service;
means for redirecting network traffic comprising client requests to access said computer service from said first network to said second network;
means for selecting a traffic processing node of said second network for receiving said redirected network traffic;
means for determining for every client request for access to said computer service an optimal computing node among said set of computing nodes running said computer service by said traffic processing node via said load balancing means; and
means for routing said client request to said optimal computing node by said traffic processing node via said second network.

21. The system of claim 20, wherein said load balancing means comprises a load balancing and failover algorithm.

22. The system of claim 20, wherein said second network comprises an overlay network superimposed over said first network.

23. The system of claim 20, further comprising means for inspecting said redirected network traffic by said traffic processing node and means for routing all client requests originating from the same client session to the same optimal computing node.

24. The system of claim 20, wherein said network accessible computer service is accessed via a domain name within the first network and wherein said means for redirecting network traffic resolves said domain name of said network accessible computer service to an IP address of said traffic processing node of said second network.

25. The system of claim 20, wherein said network accessible computer service is accessed via a domain name within the first network and wherein said means for redirecting network traffic adds a CNAME to a DNS record of the domain name of said network accessible computer service and resolves the CNAME to an IP address of said traffic processing node of said second network.

26. The system of claim 20, wherein said network accessible computer service is accessed via a domain name within the first network and wherein second network further comprises a domain name server (DNS) node and wherein said DNS node receives a client DNS query for said domain name and resolves said domain name of said network accessible computer service to an IP address of said traffic processing node of said second network.

27. The system of claim 20, wherein said traffic processing node is selected based on geographic proximity of said traffic processing node to the request originating client.

28. The system of claim 20, wherein said traffic processing node is selected based on metrics related to load conditions of said traffic processing nodes of said second network.

29. The system of claim 20, wherein said traffic processing node is selected based on metrics related to performance statistics of said traffic processing nodes of said second network.

30. The method of claim 20, wherein said traffic processing node is selected based on a sticky-session table mapping clients to said traffic processing nodes.

31. The system of claim 21, wherein said optimal computing node is determined based on said load balancing algorithm and wherein said load balancing algorithm utilizes one of optimal computing node performance, lowest computing cost, round robin or weighted traffic distribution computing criteria.

32. The system of claim 20, wherein said traffic processing nodes comprise virtual machines nodes.

33. The system of claim 20, wherein said second network comprises traffic processing nodes distributed at different geographic locations.

34. The system of claim 20, further comprising monitoring means and wherein said monitoring means monitor the status of said traffic processing nodes and said computing nodes.

35. The system of claim 34, wherein upon detection of a failed traffic processing mode or a failed computing node by said monitoring means, the system redirects in real-time network traffic to a non-failed traffic processing node and routes client requests to a non-failed computing node, respectively.

36. The system of claim 34, wherein said optimal computing node is determined in real-time based on feedback from said monitoring means.

37. The system of claim 20, wherein said second network scales its processing capacity and network capacity by dynamically adjusting the number of traffic processing nodes.

38. The system of claim 20, wherein said computer service comprises one of a web application, web service or email service.
